(19) United States
(12) Patent Application Publication
(10) Pub. No.: US 2026/0057389 A1
(43) Pub. Date: Feb. 26, 2026

(54) METHOD AND SYSTEM FOR MANAGING MONEY TRANSACTIONS BETWEEN A SELLER AND A BUYER

(71) Applicants: Ido SHINO, Moshav Magen Shaull (IL); Israel SABAG, Moshav Magen Shaull (IL)

(72) Inventors: Ido SHINO, Moshav Magen Shaull (IL); Israel SABAG, Moshav Magen Shaull (IL)

(21) Appl. No.: 19/119,528

(22) PCT Filed: Jul. 6, 2023
(86) PCT No.: PCT/IB2023/056997

§ 371 Date: Apr. 9, 2025

Related U.S. Application Data
(60) Provisional application No. 63/358,560, filed on Jul. 6, 2022.

(51) Int. Cl. G06Q 20/40; G06Q 20/02

(52) U.S. Cl. CPC G06Q 20/405; G06Q 20/02

(57) ABSTRACT

A computer implemented method and system including the steps of: engaging, by a consumer, a provider for the purpose of purchasing a commodity or service; effecting a contract, via a user interface of a 3^{rd} party system, of agreed-upon milestones and payment per milestone; receiving, in a financial account associated with the 3^{rd} party system, at least a partial amount of funds for the payment per milestone from the consumer; verifying, by the 3^{rd} party system, that a respective milestone of the agreed-upon milestones has been met; and providing instructions for transferring the funds for the payment per milestone to the provider.

### FIELD OF THE INVENTION

The present invention relates to a platform and method for providing a virtual trustee and, more particularly, to a computer implemented method and system for handling transactions between a buyer and seller where there is no established trust between the parties.

### BACKGROUND OF THE INVENTION

Initially a user (consumer/purchaser) engages a service or commodity provider for the purposes of purchasing a service or commodity. This may be a relatively simple transaction such as purchasing a commodity (or service) from an untrusted source. On the one hand the user does not want to release the funds until the commodity arrives. On the other hand, the provider does not want to part with the commodity (or provide the service) without receiving payment.

Historically, the manner in which this problem was overcome was by effecting the trade face to face: hand over the commodity and receive the payment. Even with remote transactions, where the potential for misconduct is much greater than an in-person transaction, the problem was often solved by entrusting a messenger with the mission of being your agent or proxy whom you dispatched to the remote location to act on your behalf, whether the purchaser or the commodity provider.

Today, for example with online shopping, the messenger is not entrusted with the financial aspect of the transaction, but rather only with the physical aspect, moving the commodity from point A to point B. With online shopping, the purchase is made upfront, and once the money has been paid, the commodity is sent via messenger. There is a certain amount of trust that exists between the individual user and the online store, especially if the online store is large and well known.

However, today, many purchases are effected directly between two individuals, and in many cases, there is no existing trust between the parties. For example, purchasing a custom-made table from an artisan. This product may be very time-consuming to make and very expensive to buy. In such a scenario, both parties have a risk. The artisan risks investing money for the raw materials and time on creating the product, when there is the possibility that the purchaser will say they no longer want the product or claim that they never ordered it in the first place. The purchaser risks paying money upfront and receiving nothing in return. Without appointing a neutral third party to hold the funds, there is inherent risk in such a transaction.

The same is true for a service that is requested by a purchaser and provided by a service provider. Especially when the service is provided remotely from the service consumer/purchaser. For example, a property manager who is hired to service (cleaning, maintenance, paying utility bills, receiving rental payments from tenants, etc.) a property that is located remotely from the owner of the property. The owner cannot be sure that, for example, a given job has been, or will be done (e.g., apartment cleaned), or that the job was necessary in the first place. On the flip side, the manager (service provider) may perform a job (e.g., cleaning the apartment), but then the owner (consumer) may not pay for the work. So, both parties lack a trusted intermediary who/that is objective and can hold the funds until proven that the work is done.

### SUMMARY OF THE INVENTION

According to the present invention there is provided a computer implemented method including causing at least one processor to execute instructions stored in non-transient memory to perform the steps of: engaging, by a consumer, a provider for the purpose of purchasing a commodity or service; effecting a contract, via a user interface of a 3^{rd} party system, of agreed-upon milestones and payment per milestone; receiving, in a financial account associated with the 3^{rd} party system, at least a partial amount of funds for the payment per milestone from the consumer; verifying, by the 3^{rd} party system, that a respective milestone of the agreed-upon milestones has been met; and providing instructions for transferring the funds for the payment per milestone to the provider.

According to further features the consumer engages the provider over a network-based website or application. According to further features the website or application is a system-native website or application, or a non-native website or application.

According to further features the system-native website or application is in communication with a product and service directory that is cross referenced with a provider directory such that the consumer can select a product or service from the product and service directory and then select the provider from a list of providers generated from the provider directory.

According to further features the user interface facilitates interaction with a contract creator engine adapted to facilitate creation of the contract or retrieval of the contract from a contracts database, and wherein each new contract is added to the contracts database.

According to further features a machine learning (ML) engine is trained on data sets including data from the contracts database and the ML engine is adapted to guide the consumer and provider in creation of the contract or is adapted to create the contract based on data provided by the consumer and provider.

According to further features the financial account is an account selected from the group including: a bank account, a cryptocurrency account, and a non-bank account.

According to further features the step of verifying includes receiving evidence that the respective milestone has been met, wherein in the evidence is analyzed by an Evidence Analysis module that is enhanced by a machine learning engine that employs artificial intelligence (AI) or machine learning (ML) models to verify the evidence.

According to further features the AI or ML models employ at least one of: computer vision algorithms, prediction models, and statistical models, to analyze the evidence.

According to another embodiment there is provided a system including: a user interface via which a buyer and seller are able to interact with components of the system; a contract creator engine for generating or retrieving a contract of agreed-upon milestones and respective payment per milestone of the agreed-upon milestones, a Financial Manager module for managing receipt and payment of funds for the agreed-upon milestones and respective payment per milestone between the buyer and the seller; an evidence analysis module for verifying that each respective milestone of the agreed-upon milestones has been met, and once met, the financial manager module providing instructions for transferring the respective payment per milestone to the seller.

According to further features the system further includes a system-native website or application hosting the user interface.

According to further features the system-native website or application is in communication with a product and service directory that is cross referenced with a provider directory such that the consumer can select a product or service from the product and service directory and then select the provider from a list of providers generated from the provider directory.

According to further features wherein a machine learning (ML) engine is trained on data sets including data from the contracts database and the ML engine is adapted to guide the buyer and seller in creation of the contract or is adapted to create the contract based on data provided by the buyer, seller or both.

According to further features the Financial Manager module is partially or fully automated using Artificial Intelligence.

According to further features the Evidence Analysis module is enhanced or autonomously operated by a machine learning (ML) engine that employs artificial intelligence (AI) or ML models to verify the evidence.

According to further features the AI or ML models employ at least one of: computer vision algorithms, prediction models, and statistical models, to analyze the evidence.

According to further features the system further includes an Appeal Adjudication module adapted to receive and process appeal requests from the buyer or seller; wherein the Appeal Adjudication module is operated by: a human operator, an Artificial Intelligence, ML engine, or a combination thereof.

### BRIEF DESCRIPTION OF THE DRAWINGS

Various embodiments are herein described, by way of example only, with reference to the accompanying drawings, wherein:

FIG. 1 is a flow diagram of an example embodiment of the instant process;

FIG. 2 is a high-level diagram of components of an example embodiment of the system;

FIG. 3 is a high-level diagram 300 of an embodiment of the invention;

FIG. 4 is a diagram 400 of an example embodiment of the instant invention.

### DESCRIPTION OF THE PREFERRED EMBODIMENTS

The principles and operation of a virtual trustee system and method
according to the present invention may be better understood with reference to the drawings and the accompanying description.

The present innovative system and method provides an objective third party (also referred to herein as a ‘virtual trustee’) that can both hold the funds in escrow and ensure that milestones are met for the provision of the funds to the commodity or service provider.

The instant system is a computer-based system that has a number of sub-programs for handling various tasks. For sake of simplicity and hence improved clarity, each sub-program or computational task is indicated as being performed by a distinct computer “module”. It is, however, clear that the term module is merely representative of any appropriate manner of arranging the computer hardware, software, and/or firmware to facilitate and perform the tasks assigned to the module.

Furthermore, it is also clear that the modules form only a portion of the overall program or system. Nonetheless, for the purposes of the present document, only those portions of program/system germane to the features and processes essential to the present system and method are discussed herein.

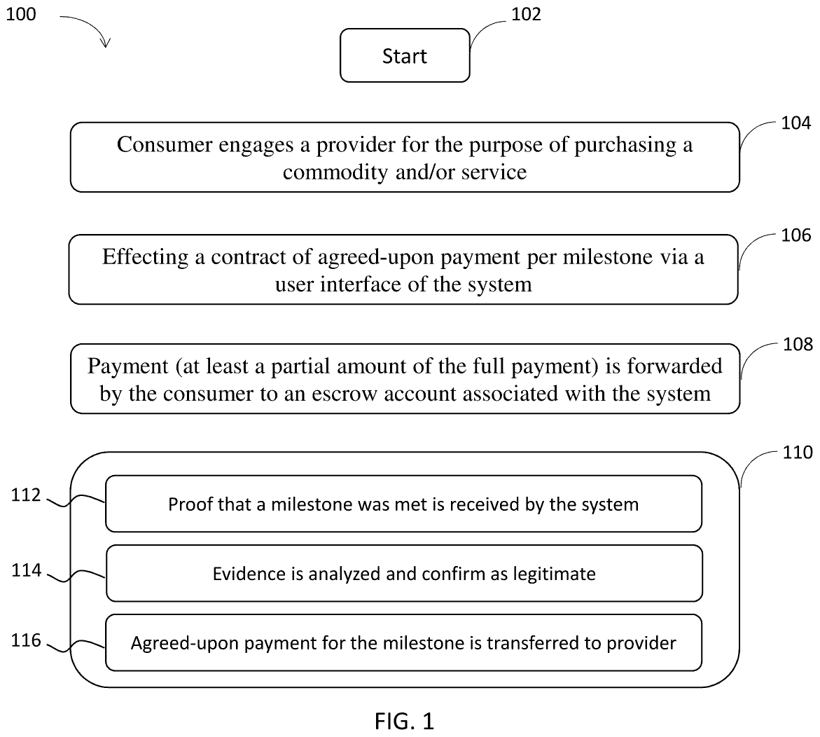

FIG. 1 illustrates a flow diagram of an example embodiment of the instant process. It is made clear that the steps of the process and the language used to describe the steps are merely representative of a multitude of manners in which the method can be performed. In embodiments, a computer-readable storage medium comprising instructions which, when executed by a computer, cause the computer to carry out the steps enumerated in the Figure and described in detail below.

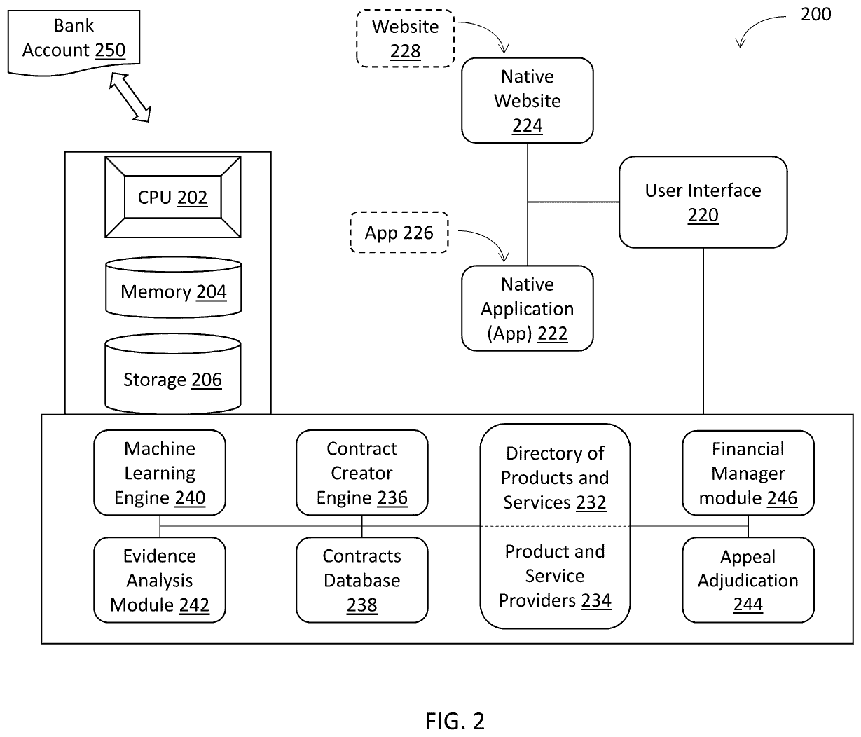

FIG. 2 illustrates a high-level diagram of components of an example embodiment of the system. It is made clear that the components of the system and the language used to describe the components are merely representative of a multitude of components, sub-components, virtual equivalents, logical implementations in which the system can be embodied. For example, the system may be embodied on a dedicated server, implemented on a networked group of computers (cloud), and/or serverless computing (see end of document for expansion and exemplary details). Essentially, there is provided computer-readable storage medium including instructions which, when executed by a computer, cause the computer to carry out the presently described method. Reference is made to both FIGS. 1 and 2.

### Engagement

FIG. 1 illustrates a flow diagram 100. FIG. 2 illustrates a high-level diagram of specific components germane to the instant system 200. At step 102 the flow diagram starts. At step 104 a consumer engages a provider for the purpose of purchasing a commodity and/or service. The consumer and provider may be collocated or remotely distanced from each other. The engagement may be via any form of communication including, but not limited to, direct speech, telephonic communication (voice and/or text), communication over a network or the Internet (e.g., via a dedicated (system) website, a dedicated app of the system, a non-dedicated website, a non-dedicated app, etc.) using a computing device such as a computer, laptop, tablet, smartphone and the like.

An app is a software application typically installed or loaded on a mobile device such as a smartphone or tablet, but also potentially used on other computing systems such as laptops and desktop computers. A dedicated or system-native app 222 (and the same is true for a dedicated website 224, such that the following description applies equally to both user interface environments) is an app (or website) that is integrally linked to the instant system 200. The dedicated app corresponds to the dedicated website and generally provides the same functionality, as is well known in the art.

The dedicated app or website offers products and/or services as well as corresponding product and/or service providers. A consumer engaging the dedicated app/website can search for products and/or services (e.g., using menus, filters, and/or search features). The list of products and services may be, for example, stored on a Directory of Products and Services 232. Once the product/service is selected, the user is presented with a list of providers. The list of providers may be, for example, stored on a Product and Service Provider database 234 (or simply ‘provider database’). The directory and database are interconnected and interrelated. The system-native website or application is in communication (e.g., over a network, such as the Internet) with a product and service directory that is cross referenced with a provider directory. The directories are stored or hosted on a system server or server-like configuration (e.g., cloud computing, serverless platforms, etc.).

In embodiments, the app/website 222, 224 allows for engaging the providers within the environment of the application/website. The providers may be selected from a pre-existing database of service providers or from a list of providers who have subscribed to the website/app/system. A hybrid list/database is also envisioned, whereby all providers from one or more existing databases are provided but subscribed providers are given preferential treatment, such as, for example, discount deals, better positioning on the list (e.g., members at the top of the list, non-members below subscribed providers), points going towards future purchases, etc. Providers may even purchase premium subscriptions (at higher rates than regular subscriptions) which afford them even better treatment by the system.

A non-dedicated/non-native app 226 or website 228 could be any website or app that in some manner has a connection to commerce, sales, service provision and/or those who deal with such things. For example, the website could be a website for an air conditioner company that offers air conditioner units for sale and, possibly, installation and/or service of the units. Such a website, for example, could include, amongst the payment options, a payment method using the instant system as a third-party, objective, payment mediation entity. In another example, the website or app could be a service provider directory or listing. In yet another example, the website or app could be a commercial website/app that facilitates the sale of commodities and/or services from one or a plurality of vendors.

The non-native or non-dedicated website 228/app 226 may either host the code for the user interface or simply include a link (or some script) that redirects the consumer to the host/dedicated/native website together with the necessary details of the selected product and/or service provider that the customer has selected. Alternatively, a link for downloading or redirecting to an installed version of the native app may be provided on the non-native website or in the non-native app. The non-native components are illustrated with broken lines to indicate that they are not an integral part of the system 200.

In some example embodiments, whether using a native or non-native website/app, the provider may be invited to engage in the potential transaction using the instant system by the website/app sending a message to the provider including a request to engage and necessary information or links with which to respond and/or engage with the customer.

Typically, an engagement includes setting up an avenue of communication and identifying the product and/or service for the transaction and an indication of a price for the product and/or service.

### Agreement

At Step 106, a contract of agreed-upon, at least partial payment, per milestone is effected via a user interface 220 of the system. In the preceding step, the consumer engages the provider for the purpose of purchasing a commodity and/or service. It is made clear that the engagement may be initiated by the provider and the customer merely agrees to this arrangement. However, it is the consumer who purchases the commodity or service from the provider, therefore, the engagement is from the customer/consumer to the provider/seller, when talking about making a purchase.

In whichever manner the engagement has come about (see above for a number of non-limiting examples), both the customer and the provider, in this step, are communicating with each other via the system's user interface. The user interface 220 may be embodied in a graphical user interface (GUI) displayed on a computing device such as a desktop/laptop computer, a tablet, smartphone and the like. The users (customer and provider) interact with the user interface which is in communication with the system server (or network of servers, cloud, serverless application, etc.), usually via a network such as the Internet.

In one example embodiment, the system includes a processing unit (e.g., CPU 202), a memory (e.g., memory 204), and storage (e.g., storage 206). The processing unit executes programs loaded into the memory from storage. The storage 206 stores programs, modules, databases, machine learning engines and the like, as detailed hereafter. A computer program product including instructions which, when the program is executed by a computer, cause the computer to carry out the methods described herein. In embodiments, the computer implemented method including causing at least one processor (e.g., CPU 202) to execute instructions stored in non-transient memory (e.g., storage 206) to perform the steps described herein.

It is made clear that the hardware, firmware and/or software components, the methods of storage and execution, and the digital/graphical representations thereof, are merely examples of non-limiting possibilities for implementing the instant system. The components named herein and depicted in the Figures are intended to be representative of corresponding components, depending on how the particular system, in a given case, is embodied.

The basis for the transaction (i.e., purchase of the goods and/or services for money) is an agreement in which the customer agrees to the amount of money and the provider agrees to provide the goods and/or services. In addition to the basic terms of the transaction, there may be additional terms, e.g., based on milestones. For example, the first milestone may be signing of the contract; in which case, the customer agrees, for example, to pay half, or a third, or any agreed upon amount, to the provider, at the time of signing. The final milestone may be delivery of the product and/or provision of the service. Once this final milestone has been reached, the customer agrees to pay the balance (remainder) of the cost or fee. For example, one agreement may be “half at signing and half on delivery”, i.e., payment of half the sum upon signing the contract and payment of the other half upon delivery of the product. The terms for payment, as used herein, refer to the 3^{rd} party system account 250 releasing/transferring the customer's money to the provider. In some, more complex situations, there may be more than two milestones (first milestone and final milestone).

The user interface 220 facilitates interaction with a contract creator engine 236 adapted to facilitate creation of the contract or retrieval of the contract from a contracts database 238. Each new contract is added to the contracts database.

A machine learning (ML) engine or Artificial Intelligence (AI) is trained on data sets including data (i.e., at least the contracts themselves) from the contracts database. The AI and/or ML engine is adapted to guide the consumer and provider in creation of the contract. Alternatively, the AI or ML engine is adapted to create the contract based on data provided by the consumer/buyer and provider/seller. For example, the AI/ML can draw up the contract/agreement based on the consumer and provider filling out a questionnaire related to the nature of the transaction and/or by providing parameter values (size, type, status [new, used, old, etc.], asking price etc.) to prompts generated by the AI/ML engine.

### Funds Held in Third Part Account

In Step 108 payment (or at least partial payment) is forwarded by the user to a third-party escrow account 250 associated with the system. Seeing as one of the advantages of the instant system is that it provides security to both parties, i.e., ensuring that neither party will lose out of the monetary aspect of the agreement, it is made clear that at least some of the money due to the provider is placed in the 3^{rd} party account before the milestones of the provider are achieved (or more precisely, before any action is taken for which remuneration is expected). In embodiments, the financial account is an account selected from the group including: a bank account, a cryptocurrency account, and a non-bank account. A non-bank account, as referred to herein, is any type of account that is not managed by a bank. This may be a digital wallet, a money transfer application and the like.

In Step 110, for each milestone that is met, an agreed-upon payment is forwarded to the service or commodity provider by the system from the escrow account, but only upon receipt by the system of proof that the respective milestone was met and confirmation of the legitimacy of the proof. Step 110 can therefore be subdivided into three steps: Step 112—receipt of proof; Step 114—analysis of proof; and Step 116—transferring of funds.

In the contract/agreement (set up in Step 106) each milestone is detailed and defined (e.g., using User Interface 220), including providing details as to what the milestone is (delivery, installation, service rendered, etc.) and how the provider must prove that the milestone has been reached (type of evidence: pictures, signed documents, etc.). For example, one milestone may be delivery of a product, such as an air conditioner unit or timber for constructing a shed. Another, subsequent milestone may be installation of the unit or assembly of the shed. The provider may, for example, take pictures of the unit or lumber being placed outside of the customer's house or a delivery bill signed by the customer. The pictures or documents are uploaded to the system which analyzes the “evidence” of the milestone being met and then transfers the agreed-upon funds (partial payment) to the provider. The next milestone would be installation of the unit or assembly of the shed. Once this task has been completed, the provider takes a picture or pictures of the installed/assembled product or gets a document signed by the customer attesting to the job being completed. The pictures or documents are uploaded to the system. The system analyzes the evidence and confirms that the task has been completed and then transfers the agreed-upon funds (balance of the fee) to the service provider.

In some embodiments, the user interface 220 may include sequence of menus and/or pages that the customer and/or provider navigate in order to set up the agreement. A Contract Creator Engine 236 is used to create a contract. The Contract Creator Engine 236 includes various tools, lists, examples, etc. which the users can use to create a contract which details, for example, the milestones, the evidence, and the remuneration agreed upon. A Contracts Database 238 is a database including predefined contracts that users can select, instead of creating a contract from scratch. In embodiments, predefined contracts can be modified using the Contract Creator Engine 236. In embodiments, contracts created by users are added to the Contracts Database 238. As mentioned, the AI/ML predictive and/or statistical models can generate the contracts based on parameter input by the buyer and/or seller.

A machine learning (ML) engine 240 uses the contracts and even the inputs to the contract creator engine as inputs for the ML engine 240. The ML engine can employ any artificial intelligence or machine learning model known in the art. In embodiments, the models are pretrained on data sets of types of contracts, milestones, and/or types of evidence relevant to the milestones.

The AI and ML models may be pretrained and continuously trained on all datasets relating to the system such that the system can become autonomous with little or no input from human operators and administrators.

In embodiments, the ML engine 240 is used to enhance the Evidence Analysis Module 242. In some embodiments, the Evidence Analysis Module 242 is autonomously operated by a machine learning (ML) engine that employs artificial intelligence (AI) or ML models to verify the evidence.

Evidence Analysis Module 242 is configured to receive pieces of evidence from the provider as proof of reaching a milestone or completing a task. Examples of potential types of evidence are discussed above. In another example, the milestone may be, for example, cleaning a yard. The evidence may be, for example, providing before and after images of the yard. The Evidence analysis module 242 is tasked with comparing the images and validating the evidence. For example, GPS data from the seller or messenger's phone may indicate that the seller or messenger was at the specific location. In another example, the module 242 can examine the metadata of the images to ensure that they come from the same source, that the geo-tags match the target location, the sufficient time has lapses between the “before” image and the “after” image, etc. The ML engine may be utilized, for example, to compare the images to ensure that they are images of the same location, but with the task completed. In the yard cleaning example, the ML engine uses computer vision algorithms to ascertain that the ‘before’ image includes a yard with leaves covering the yard, whereas the ‘after’ image shows the yard, without any leaves.

In cases where a consumer is not happy with the work or product (e.g., the product is damaged; the task is incomplete, etc.) the consumer may lodge a complaint or appeal against payment for the product or service. In embodiments, an Appeal Adjudication module 244 handles the complaint and analyzes whether the appeal is justified or not. Some or all of the strategies mentioned with regards to evidence analysis can be employed here as well, including use of AI and/or ML models and algorithms. In all cases, the system may refer issues to a human moderator if the automated elements are unable to reach a conclusive decision. This may be particularly relevant for evidence analysis (especially when the system is relatively new) and appeal adjudication. In embodiments, the AI or ML models employ at least one of: computer vision algorithms, prediction models, and statistical models, to analyze the evidence.

When a milestone is met, to the satisfaction of various system analysis components, a Financial Manager module 246 sub-system sends instructions to the bank to transfer money from the associated bank account 250 to the product and/or service provider account. As with other sub-systems, the Financial Manager module 246 may by autonomous operated by AI or, in some cases, forward a decision, or a task, to a human operator.

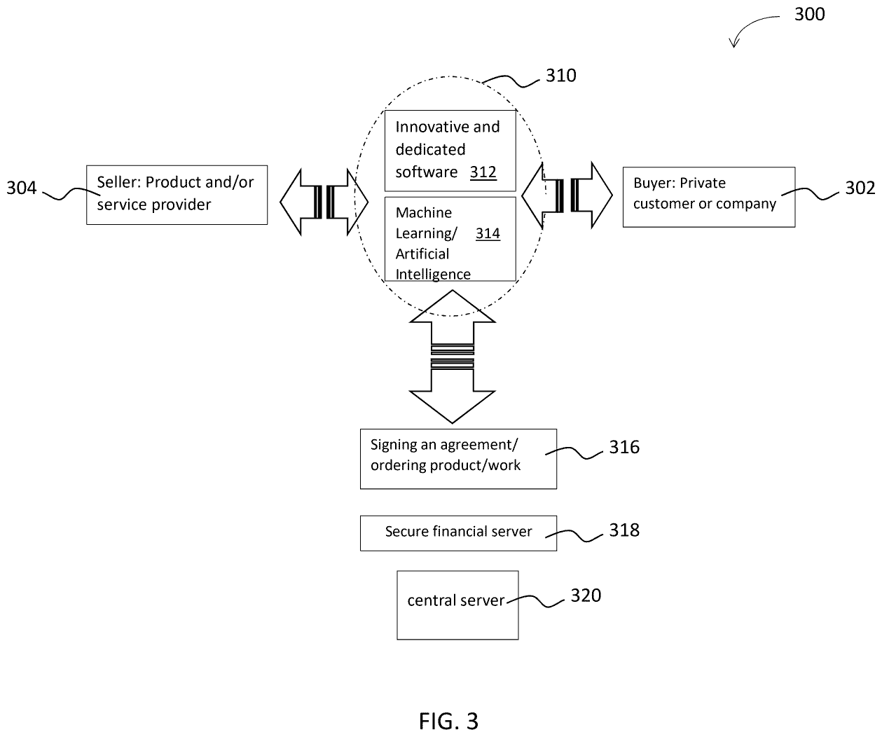

FIG. 3 depicts a high-level diagram 300 of an embodiment of the invention. As above, the interaction is between a consumer/buyer 302, e.g., a buyer who is a private customer or company, and a provider/seller 304, e.g., a product and/or service provider. The two parties interact, according to the example embodiment, via a third-party system 310, e.g., a virtual trustee. System 300 includes, at least, innovative, and dedicated software 312, e.g., in the form of an application (app) and/or website. Further, the system includes Machine Learning (ML) and/or Artificial Intelligence (AI) components and functionality 314. The ML/AI components are constantly learning how the buyers and sellers interact and adding each new contract, condition, milestone, definition, etc. to its knowledge base. That is to say that, at least, all the interactions that are taking place via the system interface are being used as input to teach the ML/AI models and improve their ability to anticipate the needs of the users. The ML/AI components are able to guide/provide suggestions to buyers and sellers with regards to creation, modification, and/or definitions of contracts, milestone, evidence and the like, based on initial input (training the ML/AI models on data sets) as well as ingoing input as the system is used more. The ML/AI models become better and better at reaching conclusions and/or making predictions, as the data sets grow from new input as more and more people use the system and create contracts, receive evidence, and analyze the evidence.

After the initial stages of engagement and interaction via the system interface, the agreement is prepared and ready for signing. Block 316 indicates the step of signing the agreement and/or ordering the product/service (which is an implicit agreement to respect the terms of the explicit agreement or implicit agreement that comes with ordering a product or service).

One of the main functions of the instant system is to hold the money/funds in escrow until the terms of the transaction have been fulfilled. To this end, in the instant example embodiment, a financial server 318 handles all the financial aspects of the transactional agreement. The funds may be money, which is wired between bank accounts, money transferred via payment applications, digital currency such as cryptocurrency, and/or any manner of transferring of funds from one party to a second party (i.e., buyer to seller). Accordingly, the financial server 318 is configured to transfer any type of funds, in any manner, as agreed upon by the parties.

A central server 320 is representative of any manner of computing arrangement that facilitates the system as described herein. Various computing configurations are well known in the art, and one of skill would know how to implement the present system using any computer arrangement or configuration known in the art.

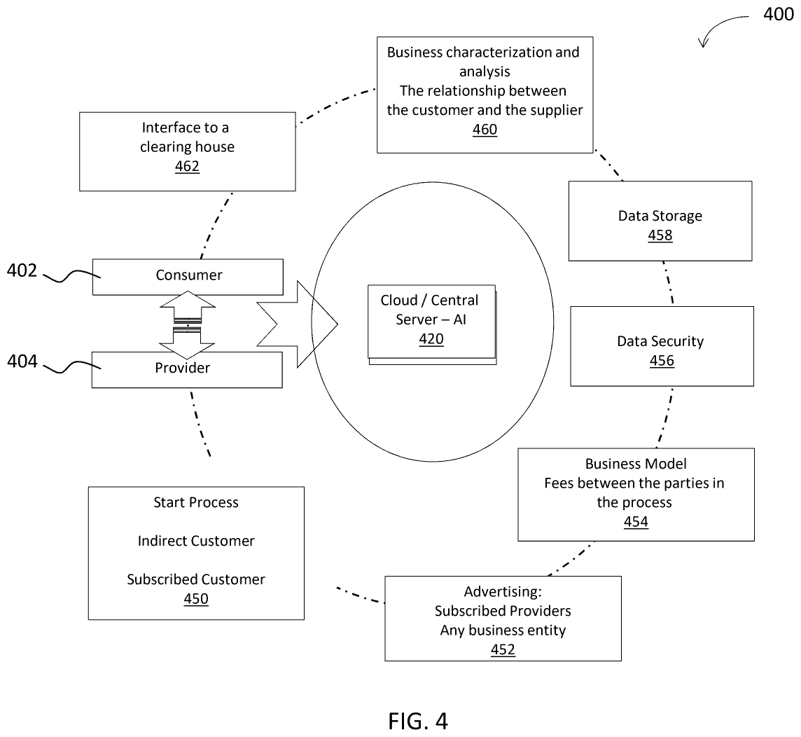

FIG. 4 depicts a diagram 400 of an example embodiment of the instant invention. The process starts at block 450 where the customer initiates the process using either a native interface or (at least initially) via a non-native interface. A native interface is, for example, a native website of the system or a native application of the system. A native or dedicated website/app has been described and detailed elsewhere herein and that detail and description should be seen as if repeated here in full.

Indeed, any process, structure, and/or feature mentioned herein with relation to one example or embodiment is intended to apply, mutatis mutandis, to every example and embodiment where relevant.

A non-native interface is any indirect means by which the customer engages the system. A description and detail of an example of a non-dedicated or non-native website or app has been described and detailed elsewhere herein and that detail and description should be seen as if repeated here in full.

To add to those descriptions, it is noted that the user may be an indirect or incidental customer, reaching the system interface via a non-native website/app. In some embodiments, the user may be subscribed (i.e., be a member) to a website/app/service and that website/app/service may have a relationship with the instant system. The relationship may be a monetary relationship or a relationship whereby the entities share information (e.g., user information, such personal details, online tracking information, user history information and the like) or some combination of the two. One simple example may be that a user that is subscribed to a [non-native] service may be given a coupon or discount or limited number of free uses of the native service of the instant system. This type of relationship may be unilateral or bilateral.

Alternatively, the customer may subscribe or be a member of the native system and seek products and/or services via the native system, for example, in one of the manners described elsewhere in.

Block 452 entails the advertising feature in the system. As with many websites, applications, services and the like, advertising may be one of the main sources of revenue for a business entity running the instant system. Advertising may come in various forms. In one non-limiting example, a non-native business entity (i.e., a business that may have nothing to do with the instant system, or may only tangentially be related to the instant system or to products supported by the instant system), may advertise on the website or in the app (pop-up advert, banner, etc.).

In another non-limiting example, the providers on the system may advertise. For example, a non-paying provider user of the system may not appear anywhere in the listings of providers or may appear very low down on the list of providers (e.g., for a given product/service).

A paying provider user is generally referred to herein as a subscribed user/provider or a member (or membership holder) of the system (also referred to herein as a platform). Subscriber providers/sellers may be listed higher up in the listings; or the listings may only include paying members; or the subscriber sellers may have a fee schedule whereby paying more money gives the seller more exposure or better exposure, i.e., seller members get advertised either as simply being a subscribed user or as a result of paying a higher premium for the membership.

Block 454 denotes the business model aspect of the platform. Part of the general business model of the platform includes the Advertising denoted in Block 452. However, more specifically, the business model here refers to the fees or commission the platform receives for providing the service of a third-party, objective, virtual trustee as opposed to a fee for hosting the directory of products/service and sellers/providers. Here too, the buyers and sellers may be subscribed users, where the platform receives the fee in the form of a subscription fee (e.g., a flat fee, a fee for a limited time period, a fee per transaction, etc.). Alternatively, or additionally, a portion of the funds paid by the customer may be appropriated, e.g., as a commission (such as a flat fee or a percentage of the transaction, or a combination thereof, etc.) by the platform, under the agreement agreed on by the parties interacting with the platform.

It is made clear, that in some embodiments, the platform does not host the business listings (sellers/providers) and product and services listing. In such embodiments, the platform/system/service merely facilitates the secured transaction between two parties, playing the role of the virtual trustee. This type of embodiment (which may be a variation of any of the aforementioned configurations, including the configuration discussed with reference to FIG. 2 and diagram 200), may be used to facilitate a transaction between two individuals, where the seller is not a business or repeat provider of the product or service, but rather wishing to sell a product or provide a service in a one-off manner. For example, selling a car or bike, or even a home and the like.

Block 456 denotes the Data Security feature. This feature and functionality may be embodied in any manner known in the art. It is clear that wherever there are financial transactions, there needs to be very stringent Data Security. Furthermore, personal information of the buyer and/or sellers must be guarded as well.

Block 458 denotes the Data Storage feature of the platform. Contracts, evidentiary materials, communications, are all securely stored by the platform as well as any other data that is pertinent to parties and the transaction.

Block 460 denotes the characterization and analysis of the transactional relationship between the customer (buyer) and the supplier (seller). This feature encompasses the contractual relationship between the parties. The contract includes, for example: the amount of money for the product and/or service; a detailed accounting of what the production and/or service is; description or definition of one or more milestones that need to be met; manner in which the milestones can be confirmed as having been met; payment per milestone; method of payment; acknowledgement of the platform fee or commission (at least by the seller); and/or any combinations of the aforementioned. Examples and details of the agreement feature have been detailed elsewhere herein, those details and descriptions are relevant here and should be seen, mutatis mutandis, as if repeated here in full.

Block 462 denotes the clearing house or company or feature employed by the platform. A clearing house/corporation/facility/feature is an organization or entity associated with an exchange to handle the confirmation, settlement, and delivery of transactions. Clearing corporations fulfill the main obligation of ensuring transactions are made in a prompt and efficient manner. In example embodiments, a clearing house is used to facilitate transfer of funds. In other embodiments, this function is facilitated by the platform itself (e.g., by software, hardware, and/or administrative oversight). Methods and types of funds and currencies have been discussed in detail elsewhere herein. Those details and descriptions are relevant here and should be seen, mutatis mutandis, as if repeated here in full.

All of the aforementioned components, features, and/or processes make up at least part of the platform/system which is then used by a consumer 402 and a provider 404 to facilitate a transaction. All of the aforementioned components, features, and/or processes that make up at least part of the platform/system are controlled by, or in communication with, or facilitated by, a central server 420 (representative of any computing configuration for the same, such as, but not limited to: cloud server, serverless platform, server(s), and the like). As discussed elsewhere herein, in embodiments, one, a few, or all aspects of the instant platform are effected or assisted by ML and/or AI systems.

### Additional Information

In cloud computing platforms, serverless computing is a new emerging technology that provides a cloud computing execution model in which the cloud provider dynamically manages the allocation of machine resources. Such platforms, also referred to as function as a service (FaaS) platforms, allow executing application logic but do not store data. Commercially available platforms include AWS Lambda by Amazon®, Azure® Functions by Microsoft®, Google Cloud Functions Cloud Platform by Google®, Cloud Functions by IBM®, and the like.

Serverless applications are made up of disparate components, such as serverless functions and cloud services that are configured to work together in a certain logical order and serve a pre-determined logic based on the application's design.

Machine learning (ML) is a branch of artificial intelligence (AI) that leverages data to improve computer performance by giving machines the ability to “learn”.

Machine learning algorithms build a model based on sample data, known as training data, in order to make predictions or decisions without being explicitly programmed to do so. Machine learning algorithms are used in a wide variety of applications, such as in medicine, email filtering, speech recognition, agriculture, and computer vision, where it is difficult or unfeasible to develop conventional algorithms to perform the needed tasks. As used herein, the ML algorithms are employed, for example, for creating or assisting in the creation of contracts. ML algorithms are also employed, for example, as part of the Evidence Analysis Module or subsystem that analyzes the evidence that is provided as proof that a milestone has been met or a proof that a milestone has not been met, or not been met to a satisfactory degree. For example, ML algorithms for computer vision can be employed to analyze uploaded images that are intended to show before and after images of a task. The models may be trained on images of products so as to be able to recognize given features in an image.

A subset of machine learning is closely related to computational statistics, which focuses on making predictions using computers, but not all machine learning is statistical learning. The study of mathematical optimization delivers methods, theory and application domains to the field of machine learning. Data mining is a related field of study, focusing on exploratory data analysis through unsupervised learning.

Some implementations of machine learning use data and artificial neural networks in a way that mimics the working of a biological brain.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A computer implemented method, comprising causing at least one processor to execute instructions stored in non-transient memory to perform the steps of:
engaging, by a consumer, a provider for the purpose of purchasing a commodity or service;
effecting a contract, via a user interface of a 3^{rd} party system, of agreed-upon milestones and payment per milestone;
receiving, in a financial account associated with the 3^{rd} party system, at least a partial amount of funds for said payment per milestone from the consumer;
verifying, by the 3^{rd} party system, that a respective milestone of said agreed-upon milestones has been met; and
providing instructions for transferring said funds for said payment per milestone to said provider.

2. The method of claim 1, wherein the consumer engages the provider over a network-based website or application.

3. The method of claim 2, wherein the website or application is a system-native website or application, or a non-native website or application.

4. The method of claim 3, wherein the system-native website or application is in communication with a product and service directory that is cross referenced with a provider directory such that the consumer can select a product or service from the product and service directory and then select the provider from a list of providers generated from the provider directory.

5. The method of claim 1, wherein the user interface facilitates interaction with a contract creator engine adapted to facilitate creation of the contract or retrieval of the contract from a contracts database, and wherein each new contract is added to the contracts database.

6. The method of claim 5, wherein a machine learning (ML) engine is trained on data sets including data from the contracts database and the ML engine is adapted to guide the consumer and provider in creation of the contract or is adapted to create the contract based on data provided by the consumer and provider.

7. The method of claim 1, wherein the financial account is an account selected from the group including: a bank account, a cryptocurrency account, and a non-bank account.

8. The method of claim 1, wherein the step of verifying includes receiving evidence that the respective milestone has been met, wherein in the evidence is analyzed by an Evidence Analysis module that is enhanced by a machine learning engine that employs artificial intelligence (AI) or machine learning (ML) models to verify the evidence.

9. The method of claim 8, wherein the AI or ML models employ at least one of: computer vision algorithms, prediction models, and statistical models, to analyze the evidence.

10. A system comprising:
a user interface via which a buyer and seller are able to interact with components of the system;
a contract creator engine for generating or retrieving a contract of agreed-upon milestones and respective payment per milestone of the agreed-upon milestones;
a Financial Manager module for managing receipt and payment of funds for the agreed-upon milestones and respective payment per milestone between the buyer and the seller;
an evidence analysis module for verifying that each respective milestone of said agreed-upon milestones has been met, and once met, said financial manager module providing instructions for transferring said respective payment per milestone to said seller.

11. The system of claim 10, further comprising:
a system-native website or application hosting the user interface.

12. The system of claim 11, wherein the system-native website or application is in communication with a product and service directory that is cross referenced with a provider directory such that the consumer can select a product or service from the product and service directory and then select the provider from a list of providers generated from the provider directory.

13. The system of claim 10, wherein a machine learning (ML) engine is trained on data sets including data from the contracts database and the ML engine is adapted to guide the buyer and seller in creation of the contract or is adapted to create the contract based on data provided by the buyer, seller or both.

14. The system of claim 10, wherein the Financial Manager module is partially or fully automated using Artificial Intelligence.

15. The system of claim 10, wherein the Evidence Analysis module is enhanced or autonomously operated by a machine learning (ML) engine that employs artificial intelligence (AI) or ML models to verify the evidence.

16. The system of claim 15, wherein the AI or ML models employ at least one of: computer vision algorithms, prediction models, and statistical models, to analyze the evidence.

17. The system of claim 10, further comprising:
an Appeal Adjudication module adapted to receive and process appeal requests from the buyer or seller;
wherein the Appeal Adjudication module is operated by: a human operator, an Artificial Intelligence, ML engine, or a combination thereof.

18. A computer program product comprising instructions which, when the program is executed by a computer, cause the computer to carry out the method of claim 1.
